(19) United States
(12) Patent Application Publication
(10) Pub. No.: US 2025/0133487 A1
(43) Pub. Date: Apr. 24, 2025

(54) SYSTEM AND METHOD FOR ENROLLING APPLICATIONS TO ENABLE ACCESS TO NETWORK SLICE SERVICES

(71) Applicant: Verizon Patent and Licensing Inc., Basking Ridge, NJ (US)

(72) Inventors: Yousif Targali, Sammamish, WA (US); Vinod Kumar Choyi, Conshohocken, PA (US)

(21) Appl. No.: 18/489,529

(22) Filed: Oct. 18, 2023

(51) Int. Cl. H04W 48/18; H04W 4/50; H04W 12/086; H04W 40/02; H04W 76/10

(52) U.S. Cl. CPC H04W 48/18; H04W 4/50; H04W 12/086; H04W 40/02; H04W 76/10

(57) ABSTRACT

A device may include a processor. The processor may be configured to: receive, from a User Equipment device (UE) over a wireless connection, a request to enroll an application installed on the UE to receive a service from a network slice; select a network slice to provide the service to the application on the UE; bind the application on the UE to the selected network slice; and send an enrollment reply to the UE. The processor may perform a dynamic, short-term application enrollment or a long-term application enrollment, to enable the application to access the service.

### BACKGROUND INFORMATION

Fifth Generation (5G) networks offer many technological features unavailable in predecessor networks. For example, through use of network slicing, 5G networks may provide application and subscriber-specific Quality-of-Service (QOS) services for variety of applications. Other benefits of network slicing may include improved network resource utilization, faster rollout times for new services without significant modifications to the existing network infrastructure, and increased security. Network slicing may take a more prominent role in 5G as operations of Internet-of-Things (IoT) devices, such as autonomous vehicles or sensor devices, require greater connectivity and increased online presence.

### BRIEF DESCRIPTION OF THE DRAWINGS

FIG. 1 illustrates an overview of a system for enrolling applications to receive network slice services.

FIG. 2 illustrates an exemplary network environment in which a system described herein may be implemented.

FIG. 3 depicts example components of a User Equipment device (UE) according to an implementation.

FIG. 4 illustrates example fields of records in a cryptography database (DB),

according to an implementation.

FIG. 5 illustrates example components of a core network, according to an implementation.

FIG. 6 illustrates examples components of a Slice Enrollment Function (SEF), according to an implementation.

FIG. 7 depicts example fields of a record in an app-slice bindings database (DB), according to an implementation.

FIG. 8 is a flow diagram of an exemplary process that is associated with a system for enrolling applications to enable access to network slice services, according to an implementation.

FIG. 9 illustrates example messages that are exchanged by a system for enrolling applications to be able to access network slice services, according to an implementation.

FIG. 10 depicts example functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network.

As used herein, the term “session” may refer to a series of communications, of a limited duration, between two endpoints (e.g., two applications). When a session is said to be established between an application and a network slice, the session is established between the application and another application/server on the network slice. Similarly, if a session is said to be established between a device and a network slice or a network, the session is established between an application on the device and another application on either the network slice or the network.

As used herein, the term “Protocol Data Unit (PDU) session” may refer to communications between a mobile device and another endpoint (e.g., a data network, a network slice, etc.). Depending on the context, the term “session” may refer to a session between applications or a PDU session. Additionally, depending on the context, the term “connection” may refer to a session, a PDU session, or another type of connection (e.g., a radio frequency link between a device and a base station).

Systems and methods described herein relate to enrolling application to enable access to network slice services. Currently, there is no standard process for enrolling an application (e.g., an application running on a User Equipment device (UE)) at a provider network, to have the application gain secure access to a particular network slice that meets the requirements of the application. Typically, a provider network selects and assigns a network slice to a particular UE, rather than to a particular application running on the UE. Since the most granular endpoint of a session is likely to be an application, rather than a UE, such a selection and an assignment of a network slice can lead to unduly complex schemes that, in effect, set the endpoints of the communication as the application and the network slice. The schemes can lead to significant costs to Mobile Network Operators (MNOs) that build network infrastructures with 5G network slicing capabilities. Lacking the ability for dynamic enrollment and controlling application access to slice services could prevent the MNOs from being able to monetize the slice infrastructure investment.

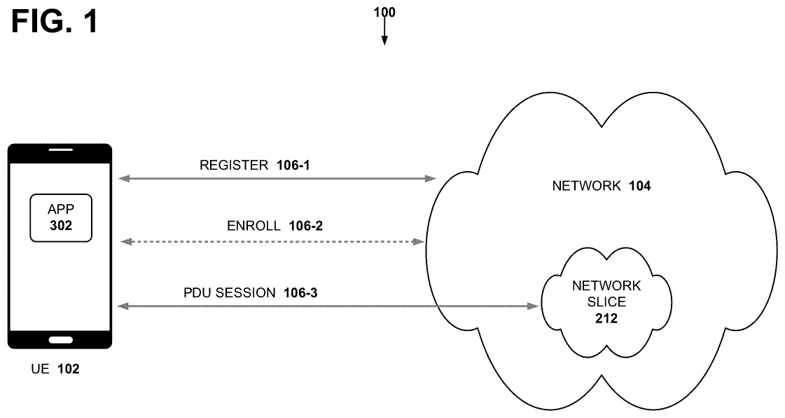

FIG. 1 illustrates an overview of a system 100 for enrolling applications to enable access to network slice services. As shown, a UE 102 includes at least one application 302 (app 302). After UE 102 powers up, UE 102 may register with a provider network 104 (e.g., a cellular network) (arrow 106-1). After the registration, application 302, which has started on UE 102, may attempt to cause UE 102 to set up a connection with provider network 104 so that application 302 can communicate with a network slice and receive services from the network slice. When UE 102 receives the request to connect, from application 302, UE 102 determines whether application 302 is enlisted with network 104 to receive the services from a network slice or provide services to the network slice (e.g., UE 102 may transmit data that can be consumed by third parties); and if not, UE 102 may enroll the application 302 at network 104 (arrow 106-2). When network 104 enrolls application 302, network 104 selects network slice 212 and assigns network slice 212 to application 302. Once application 302 is enrolled, UE 102 may establish a connection with network slice 212, and application 302 may establish a session with network slice 212 to receive its services (arrow 106-3). As used herein, the term “services” may be broadly interpreted to include any type of communication or content services (e.g., an Internet connection services, content/data delivery services, enhanced multimedia broadband services (eMBB), ultra reliable low latency communication services, etc.). If the user of UE 102 or another entity (e.g., network 104) determines that application 302 should no longer be registered (e.g., the user has upgraded his or her subscription at network 104), UE 102 may send a request to de-enroll or de-enlist application 302 from the current network slice services. The enrollment in FIG. 1 may be a short-term or a long-term dynamic enrollment (e.g., online enrollment which could authorize application access to network slice services in real time).

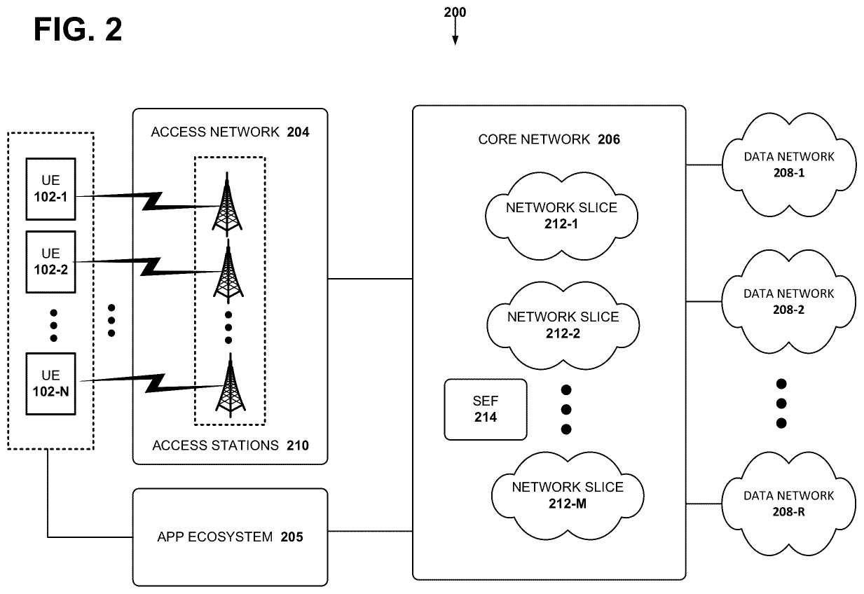

FIG. 2 illustrates an exemplary network environment 200 in which system 100 may be implemented. As shown, environment 200 may include UEs 102-1 through 102-N (collectively referred to as UEs 102 and generically referred to as UE 102), an access network 204, an app ecosystem 205, a core network 206, and data networks (DNs) 208-1 through 208-M (collectively referred to as data networks 208 and generically as data network 208). Access network 204, core network 206, and data networks 208 may be part of provider network 104 (shown in FIG. 1 but not in FIG. 2).

UEs 102 may include wireless communication devices capable of 5G New Radio (NR) communication. Some UEs 102 may include Fourth Generation (4G) (e.g., Long-Term Evolution (LTE)) communication capabilities or a combination of 5G and 4G communication capabilities (e.g., Evolved-Universal Terrestrial Radio Access-New Radio-Dual connectivity (EN-DC) capability). Examples of UE 102 include: a Fixed Wireless Access (FWA) device; a Customer Premises Equipment (CPE) device; a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor or; and an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

Each UE 102 may include one or more of application 302 that receive services from one or more network slices 212. In addition, UE 102 may include a software component that enrolls the applications at network 104. The enrollment may be a short-term or a long-term dynamic enrollment (e.g., online enrollment which could authorize application access to network slice services in real time). After such enrollment, application 302 may establish a session with a particular network slice 212.

Access network 204 may allow UEs 102 to access core network 206. To do so, access network 204 may establish and maintain, with participation from UEs 102, an over-the-air channel with UEs 102; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210, for establishing and maintaining over-the-air channel with UEs 102. In some implementations, access station 210 may include a 4G, 5G, or another type of base station (e.g., eNB, gNB, etc.) that comprises one or more radio frequency (RF) transceivers. In some implementations, access station 210 may be part of an evolved Universal Mobile Telecommunications Service (UMTS) Terrestrial Radio Access Network (eUTRAN).

App ecosystem 205 may include one or more components (e.g., a cloud, a network, servers, etc.) that support purchase or licensing of applications (e.g., payment mechanisms), downloading and/or installing applications at UEs 102, and/or providing application information (e.g., application metadata, application ID, descriptions of applications, etc.) to network devices or components. In some implementations, app ecosystem 205 may include one or more mechanisms to generate app-related credentials (e.g., slice authorization credentials) as certificate authorities and provide the credentials to authorized network components (e.g., to SEF 214 (to be described below)).

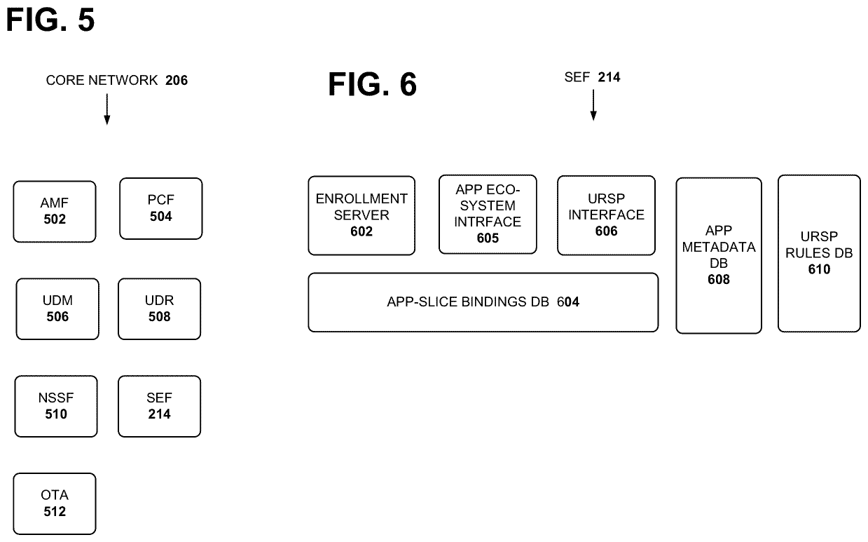

Core network 206 may include one or more devices and network components for providing communication services to UEs 102. For example, core network 206 may permit UEs 102 to attach to network 104, establish sessions with devices in network 104, and/or receive services from network 104 (e.g., receive content, access the Internet, conduct video conferences with other UEs 102 attached to network 104). To deliver various services, core network 206 may interface with other networks, such as data networks 208. To render these services and to perform the core functions of network 104, core network 206 may include 5G core network components or 4G (e.g., LTE) core network components. Some of the 5G core network components, herein referred to as network functions (NFs), are described below with reference to FIG. 5.

As further shown, core network 206 may include one or more network slices 212-1 to 212-M (collectively referred to network slices 212 and generically referred to as network slice 212). Depending on the implementation, network slices 212 may be implemented within other networks, such as access network 204 and/or data networks 208. Access network 204, core network 206, and data networks 208 may include multiple instances of network slices 212. Each network slice 212 may be instantiated as results of network slicing, which involves a form of virtual network architecture that enables multiple logical networks to be implemented on top of a shared physical network infrastructure using software defined networking (SDN) and/or network function virtualization (NFV). Each logical network, referred to as a “network slice,” may encompass an end-to-end virtual network with dedicated storage and/or computational resources that include access network components, clouds, transport components, Central Processing Unit (CPU) cycles, memory, etc. Furthermore, each network slice 212 may be configured to meet a different set of requirements and may be associated with a particular QoS Class Identifier (QCI), 5G QOS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example. Each network slice 212 may be associated with an identifier, herein referred to as a Single Network Slice Selection Assistance Information (S-NSSAI) and/or a network slice instance ID. Many components in core network may manage S-NSSAIs (or simply NSSAI).

As further shown, core network 206 may further include a Slice Enrollment Function (SEF) 214. SEF 214 may accept enrollment requests from UE 102 and attempt to enroll the application to enable access to network slice services. Depending on the implementation, before, during, or after the enrollment, SEF 214 may redirect UE 102 to a Secure Payment Portal for making payments for accessing slice services. In other implementations, SEF 214 may permit UE 102 to purchase or upgrade its services-which then permits UE 102 to proceed without making a payment during the enrollment process.

An enrollment may include a selection of a network slice, assignment of the selected network slice to application 302, and forwarding enrollment information (e.g., a security token, a security key, a security certificate, etc.) in an enrollment reply to UE 102. The enrollment may be a short-term or a long-term dynamic enrollment (e.g., online enrollment which could authorize application access to network slice services in real time). SEF 214 may receive requests to de-enroll application 302 from UE 102 and, in response, de-enroll application 302.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include and/or be connected to a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), a telephone network (e.g., the Public Switched Telephone Network (PSTN) or a cellular network), an intranet, an ad hoc network, or a combination of networks. Data network 208 may include an application server (also referred to as application). An application may render services to an application running on UEs 102 and may establish communication sessions with UEs 102 via core network 206.

For clarity, FIG. 2 does not show all components that may be included in network environment 200 (e.g., routers, bridges, wireless access point, additional networks, additional access stations 210, data centers, portals, etc.). Depending on the implementation, network environment 200 may include additional, fewer, different, or a different arrangement of components than those illustrated in FIG. 2. Furthermore, in different implementations, the configuration of network environment 200 may be different.

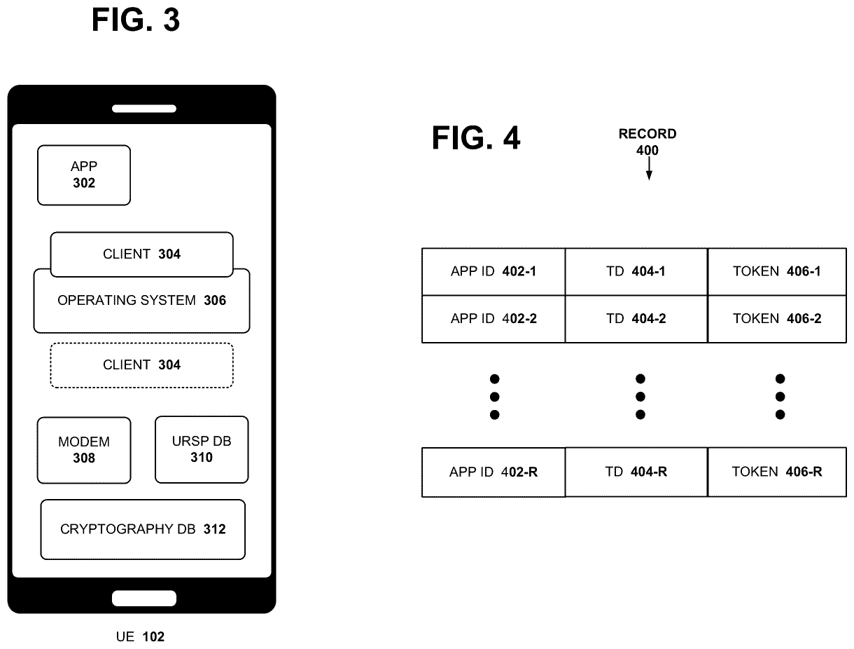

FIG. 3 depicts example components of a UE 102 according to an implementation. As shown, UE 102 may include one or more of application 302, a SEF client 304 (or simply client 304) (which may be part of an operating system 306, a modem 308, a component for managing connections, or a component between operating system 306 and modem 308), an operating system 306, a modem 308, a UE Route Selection Policy (URSP) rules database (URSP DB 310), and a cryptography database (DB) 312. Depending on the implementation, UE 102 may comprise other components or different components than those illustrated in FIG. 3.

Application 302 may include one or more software programs that run on UE 102. Application 302 may operate in conjunction with another program, also referred to as an application, an application function (AF), or an application server (AS), on network 104, on network slice 212, or on data network 208. Application 302 may include or be associated with an application ID and/or a traffic descriptor. A traffic descriptor may include an identifier (ID) that indicates a type of traffic that application 302 may exchange with network slice 212, over a connection that it establishes with network slice 212 (e.g., a video stream, an audio stream, Internet traffic, etc.). Examples of a suitable traffic descriptor include a fully qualified domain name (FQDN), a DNN, or another alphanumeric string.

Client 304 may provide a mechanism for enrolling (or enlisting) or de-enrolling (or de-enlisting) application 302 with network 104—in particular, with SEF 214 in network 104. For example, client 304 may de-enroll from SEF 214 entirely or de-enlist from a particular network slice 212. In many implementations, the functionalities of client 304 may be included in application 302. In such implementations, application 302 may perform the functions of client 304. When in operation, after application 302 launches, client 304 may examine cryptography DB 312 to determine whether application 302 is already enlisted with SEF 214. If not, client 304 may make a request to SEF 214 on network 104, to enlist application 302. To make the enrollment request, client 304 may invoke an application programming interface (API) call to lower layers of the communication system in UE 102, passing the traffic descriptor of application 302 through operating system 306 to modem 308. In the preceding, for client 304 to connect to SEF 212 so that client 304 can send an enlistment request, client 304 or UE 102 may be pre-configured with a network address (e.g., DNN, an APN, or a FQDN) of SEF 214 so that the communication system/modem 308 can reach SEF 214.

Any acknowledgement or reply from SEF 214 in response to the enrollment request may arrive at modem 308 and pass through operating system 306 to client 304. If the reply includes app slice authorization credentials (e.g., a security token, a key, or a certificate herein sometimes referred to as a token or credentials) in response to the enrollment request, client 304 may insert the received slice authorization credentials in cryptography DB 312 along with the application ID.

As a result of client 304 enrolling application 302 at network 104, UE 102 may receive what is referred to as a URSP rule from network 104. The URSP rule may map the traffic descriptor of application 302 to network slice 212 that SEF 214 assigns to application 302. After UE 102 receives the URSP rule, application 302 may start and conduct a session with network slice 212. In some implementations, application 302 may start and conduct the session via client 304, which may act as an intermediary between application 302 and operating system 306. In other implementations, application 302 may start and conduct a session with network slice 212 without having to rely on client 304.

To start the session with network slice 212 via client 304, application 302 may pass its request to establish the session to client 304, which in turn obtains the traffic descriptor of application 302 (e.g., from a local database) and passes the traffic descriptor as part of the request to modem 308 via operating system 306. After modem 308 receives the request from client 304, operating system 308 may establish a PDU session with network slice 212, after which application 302 may communicate with network slice 212 via client 304. To start a session with network slice 212 without relying on client 304, application 302 may pass its request and its traffic descriptor (as part of the request) o modem 308. After modem 308 establishes a PDU session with network slice 212, application 302 may communicate with network slice 212.

As indicated above, client 304 may also request SEF 214 in network 104 to de-enroll application 302. For example, if the user of UE 102 has upgraded its subscription at network 104, application 302 may be permitted to receive its premium-level communication services from a network slice 212 different from the network slice 212 currently assigned to application 302. In such a situation, client 304 may request SEF 214 to de-enroll application 302 and re-enroll application 302, to have SEF 214 assign a network slice 212 in accordance with the upgraded subscription.

Operating system 306 may manage applications 302, services, memory, and/or other resources on UE 102. Additionally, as indicated above, operating system 306 may relay connection requests from application 302 and/or client 304 to modem 308 and relay messages that arrive at modem 308 from network 104 to application 302 or client 304. Operating system 306 may enforce security requirements and prevent application 302 from passing some types of application-related information to other components in UE 102, such as modem 308.

Modem 308 may perform communication-related functions, including establishing connections between UE 102 and network 104, delivering messages from/to UE 102 to/from network 104, performing modulation/demodulation, performing signal processing, etc. When modem 308 receives a connection request from application 302 or client 304 via operating system 306, modem 308 may extract a traffic descriptor from the request. Modem 308 may then look up, using the extracted traffic descriptor, a URSP rule in URSP DB 310 and apply the URSP rule to obtain the identity of network slice 212 or data network 208 with which application 302 or client 304 is to establish a session. Thereafter, modem 308 may establish the connection to the identified network slice 212 or data network 208. If authentication is required to connect application 302 to the network slice 212, modem 308 ma use the traffic descriptor or the application ID to look up the slice authorization credentials (which was received during the enrollment of application 302) in cryptography DB 312. Modem 308 may use the slice authorization credentials (e.g., a token, a key, or a certificate) to obtain the authorization to establish the connection to network slice 212.

URSP DB 310 may include URSP rules. In some implementations, after application 302 is enlisted with SEF 214, SEF 214 may forward a URSP rule (which may permit modem 308 in UE 102 to identify the network slice 212 to which application 302 has been assigned by SEF 214) to UE 102. Modem 308 in UE 102 may store the URSP rule in URSP DB 310 for later use. Modem 308 may access URSP DB 310 when modem 308 looks up a URSP rule whose traffic descriptor matches the traffic descriptor in the connection request received by modem 308 from application 302 or client 304. URSP DB 310 may be hosted on a persistent storage within UE 102, such as for example, embedded Subscriber Identity Module (SIM).

Cryptography DB 312 may store app slice authorization credentials (e.g., a security token, a security key, a security certificate, etc.) along with the corresponding application IDs. As used here, depending on the context, the term “token” may refer to a security token but a security certificate, or a security key. When client 304 registers application 302 at SEF 214, SEF 214 may generate and send an app slice authorization credentials to client 304. Client 304 may then store the slice authorization credentials along with the corresponding application ID in cryptography DB 312. Modem 308 may access cryptography DB 312 to look up slice authorization credentials for application 302 when modem 308 establishes a secure connection between UE 102/application 302 and network 104.

FIG. 4 illustrates example fields of records in cryptography DB 312. As shown, each row in cryptography DB 312 corresponds to a record, which in turn may include an application ID field 402, a traffic descriptor (TD) field 404, and a token field 406. Depending on the implementation, each of the records 400 may include additional, fewer, or different fields than those shown in FIG. 4. For example, in one implementation, record 400 may not include traffic descriptor field 404.

Application ID field 402 may include an identifier that is associated with application 302 and uniquely identifies application 302. TD field 404 may include a replacement traffic descriptor that SEF 214 provides to UE 102 during the enrollment of the application 302. SEF 214 may or may not provide a replacement traffic descriptor, depending on the implementation. Token field 406 may store the slice authorization credentials that SEF 214 provides to client 304 during the enrollment of the application 302.

During an enrollment, client 304 may send an enrollment request that includes the application ID of the application 302 to SEF 214. After SEF 214 processes, authenticates, and authorizes the request, SEF 214 may generate and provide slice authorization credentials and/or a replacement TD to client 304. Client 304 may then store the application ID, the slice authorization credentials (e.g. token), and/or the traffic descriptor from SEF 214 in fields 402, 406, and/or 404, respectively.

FIG. 5 shows example components of core network 206, according to an implementation. As shown, core network 206 may include an Access and Mobility Management Function (AMF) 502, a Policy Control Function (PCF) 504, a Unified Data Management (UDM) 506, a Unified Data Repository (UDR) 508, a Network Slice Selection Function (NSSF) 510, SEF 214, and an Over-the-Air (OTA) server 512. Although not shown, core network 206 may include other core network functions, such as, for example, a Session Management Function (SMF), a user Plane Function (UPF), a Network Exposure Function (NEF), a Network Data Analytics Function (NWDAF), a Charging Function (CHF), a Network Repository Function (NRF), and Authentication Server Function (AUSF).

AMF 502 may perform registration management, connection management, reachability management, mobility management, lawful intercepts, Short Message Service (SMS) transport between UE 102 and a Short Message Service Function (SMSF), session management messages transport between UE 102 and an SMF, access authentication and authorization, location services management, functions to support non-3GPP access networks, and/or other types of management.

AMF 502 may be configured to support enrolling application to enable access to network slice services. For example, when AMF 502 receives a request from UE 102 (e.g., via access network 204) to connect to SEF 214, AMF 502 may select an SMF to manage the session between UE 102 and SEF 214. The SMF may then select a UPF to establish the session. In another example, when AMF 502 receives a request from UE 102 to connect to a particular network slice 212,

PCF 504 may support policies to control network behavior, provide policy rules to control plane functions (e.g., to a SMF), access subscription information relevant to policy decisions, perform policy decisions, and/or perform other types of processes associated with policy enforcement. To support enrolling application 302 to enable access to network slice services, PCF 504 may send policy rules to various components in core network 204. The policy rules may indicate that the recipient components are to perform their functions to support enrollment of applications 302 and for enabling access to network slice services to the enrolled applications 302.

When a particular application 302 enrolls at SEF 214, PCF 504 may obtain a URSP rule for the application 302 and the network slice 212 selected for the application 302 (e.g., generate the URSP rule based on application types/ID or receive the URSP rule from network administrators). The URSP rule may map a traffic descriptor to a slice ID of the network slice 212. When PCF 504 obtains the URSP rule, PCF 504 may send the URSP rule to SEF 214 and/or UE 102 via OTA 512 or by way of the non-access stratum (NAS) messages via AMF 502 as an intermediary to the UE 102. In response, UE 102 and/or SEF 214 may store the URSP rule.

UDM 506 may maintain subscription information for UEs 102, manage subscriptions, generate authentication credentials, handle user identification, perform access authorization based on subscription data, perform network function registration management, maintain service and/or session continuity by maintaining assignment of an SMF for ongoing sessions, support Short Messaging Service (SMS) message delivery, support lawful intercept functionality, and/or perform other processes associated with managing user data. UDR 508 may store information that UDM 506 manages. Subscription information that UDM 506 manages (and stored in UDR 508) may include UE profiles. Each UE profile may include, in addition to typical UE-related data (e.g., a UE ID), IDs of applications 302 on the UE 102, credentials assigned to the applications 302 on the UE 102, and the traffic descriptors of the applications 302. UDM 506 may also store, in a secure location (e.g. by means of a Hardware Security Module (HSM)), the slice authorization credentials for each application 302.

NSSF 510 may select a set of network slice instances to serve a particular UE 102, determine NSSAI; identify a particular AMF 502 to serve a particular UE 102; and/or perform other types of processing associated with network slice selection or management. NSSF 510 may determine whether one or more network slices corresponding to S-NSSAIs (in NSSAI) are available to provide services to an application 302 or UE 102. NSSF 510 may compile the list of S-NSSAIs that identify available network slices into a list of allowed network slices (e.g., A-NSSA) and provide the list to a service consumer function/component.

As described briefly above, SEF 214 may permit client 304 on UE 102 to enroll application 302 or de-enroll application 302. In other implementations, SEF 214 may not be part of core network 206 but part of other components of network 104, such as data network 208, access network 204, or network slice 212. OTA 512 may receive requests from network components (e.g., components in access network 204, core network 206, data network 208, or network slices 212) to download data/program to UE 102, schedule the download, and download the data/program via access network 204. For example, OTA 512 may receive a request from PCF 504 or SEF 214 to download a URSP rule to UE 102, schedule the download, and forward the URSP rule to UE 102 via access network 204.

FIG. 6 illustrates example components of SEF 214, according to an implementation. As shown, SEF 214 may include an enrollment server 602, an app-slice bindings DB 604, an app ecosystem interface 605, a URSP interface 606, an app metadata DB 608, and a URSP rules DB 610. Depending on the implementation, SEF 214 may include additional, fewer, different, or a different arrangement of components than those illustrated in FIG. 6.

Enrollment server 602 may enlist or de-enlist application 104 of UEs 102 in response to receiving the enrollment or de-enrollment request from client 304 on UE 102. An enrollment request from client 304 may include a UE ID, an application ID, and/or a traffic descriptor associated with application 302. When enrollment server 602 receives the enrollment request, enrollment server 602 may determine whether application 302 is enlisted with SEF 214, by determining whether the application ID is present in app-slice bindings DB 604 or if the application ID is assigned a slice ID. If the application ID is not present in app-slice bindings DB 604 and is not assigned a slice ID, enrollment server 602 may conclude that the application is not enlisted with SEF 214. Enrollment server 602 may then select a network slice 212 and assign the selected network slice 212 to application 302.

To select the network slice 212, enrollment server 602 may obtain network slice related information from AMF 502, UDM 504, and/or NSSF 510. For example, enrollment server 602 may request AMF 502 to provide a list of network slices that access network 204 may permit UE 102 to access; and request UDM 504 to provide a list of network slices to which UE 102 is subscribed. When requesting NSSF 510 for NSSAI, enrollment server 602 may provide, in the request, information pertaining to application 302 and/or network slice information obtained from AMF 502 and/or UDM 506. Examples of such information include application metadata (e.g., retrieved from application metadata DB 608), an application ID, a list of subscribed network slices, and a list of requirements for providing network slice services to application 302 (e.g., obtained from the enrollment request sent by client 304, such as a latency requirement, a bandwidth requirement, and/or a QoS requirement). In response, NSSF 510 may provide the S-NSSAI of the network slice 212 that will best service application 302. If NSSF 510 is not available, enrollment server 502 may identify the network slice 212 itself, based on the information from AMF 502, UDM 506, and/or app metadata DB 608.

After selecting the network slice 212 for application 302, enrollment server 602 may generate or obtain slice authorization credentials (e.g., a certificate or a token) for application 302. Next, enrollment server 602 may create a binding between application 302 and the selected network slice 212 by placing the application ID, the credentials, and a network slice ID in a record within app-slice bindings DB 604. Enrollment server 602 may locate the record by using the UE ID and/or the application ID provided in the enrollment request as lookup keys in app-slice bindings DB 604. If a record does not exist, enrollment server 602 may create a new record for the binding. Enrollment server 602 may send an enrollment reply that includes the credentials to client 304 on UE 102.

After enrolling application 302, enrollment server 602 may receive a request to de-enroll application 302 from client 304. For example, the user of UE 102 may have upgraded the services that UE 102 is to receive from provider network 104, and as a result, network 104 may need to de-enroll application 302 before enrolling application 302 for the upgraded services rendered by a different network slice 212. When enrollment server 602 receives the request to de-enroll application 302, enrollment server 602 may authenticate and authorize the request and then remove the record/binding for the application 302 from app-slice bindings DB 604.

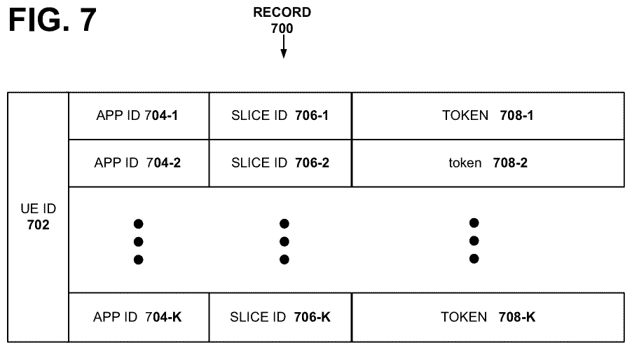

App-slice bindings DB 604 may store bindings information for applications 302 on UEs 102. FIG. 7 depicts example fields of a record 700 in an app-slice bindings database DB 604, according to an implementation. As shown, record 700 may include a UE ID field 702, app ID fields 704-1 through 704-K, slice ID fields 706-1 through 706-K, and token fields 708-1 through 708-K. Depending on the implementation, record 700 may include additional, fewer, different, or a different arrangement of fields than those illustrated in FIG. 7.

UE ID field 702 may store an ID of UE 102 which is the host of the client 304 requesting SEF 214 to enroll application 302. Examples of a UE ID include a Subscription Permanent Identifier (SUPI), a Subscription Concealed Identifier (SUCI), an International Mobile Subscriber Identity (IMSI), and a Mobile Station International Subscriber Directory Number (MSISDN(, an International Mobile Equipment Identity (IMEI), or any other device identifier. App ID field 704 may store the ID of application 302 on UE 102. Slice ID field 706 may include an ID of a network slice 212 (e.g., S-NSSAI) that enrollment server 602 or NSSF 510 selects for applicaiton302. Token field 708 may store the slice authorization credentials that enrollment server 602 obtains for application 302.

Referring to FIG. 6, app ecosystem interface 605 may interface with app ecosystem 205. By using app ecosystem interface 605, SEF 214 may obtain information pertaining to applications. For example, when app ecosystem 205 releases a new application to be purchased by the users of UEs 102 and install them on UEs 102, SEF 214 may obtain information related to the application from app ecosystem 205 via app ecosystem interface 605. The information may include, for example, an application ID, application description, application requirements (e.g., an amount of storage for installation, a communication bandwidth, security credentials, etc.). When SEF 214 obtains the information, SEF 214 may store the information in app metadata DB 608.

URSP interface 606 may interface with a network component for receiving URSP rules or forwarding URSP rules. For example, enrollment server 602 may receive one or more URSP rules from PCF 504, another network component, or an administrator via URSP interface 606. In another example, when enrollment server 602 generates a URSP rule for application 302 which is enrolling at SEF 214, enrollment server 602 may send the generated URSP rule to OTA 512, requesting OTA 512 to download the URSP rule to UE 102.

App metadata DB 608 may include metadata for different applications 302. When client 304 on UE 102 requests SEF 214 to enroll application 302, enrollment server 602 may not have all the information it needs to assign a network slice 212 to application 302. In such a case, enrollment server 602 may look up additional information (e.g., latency requirements, bandwidth requirements, QoS requirements, an application type, security and privacy requirements, etc.) pertaining to the application 302 in app metadata DB 608, using application ID as a key. URSP rules DB 610 may store URSP rules.

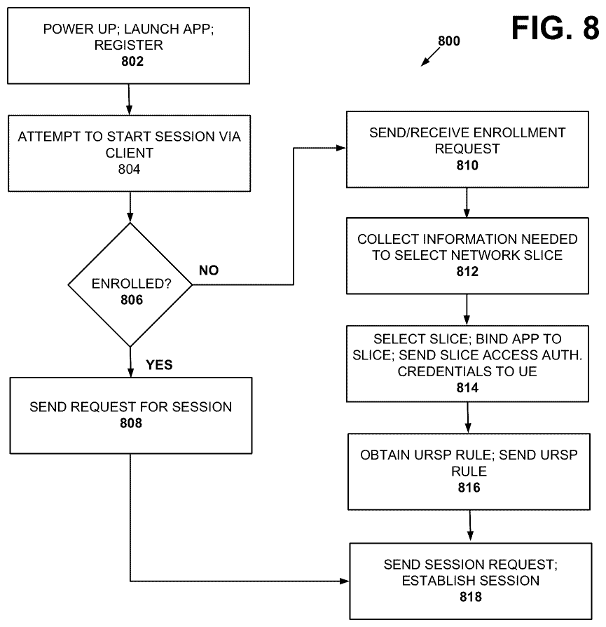

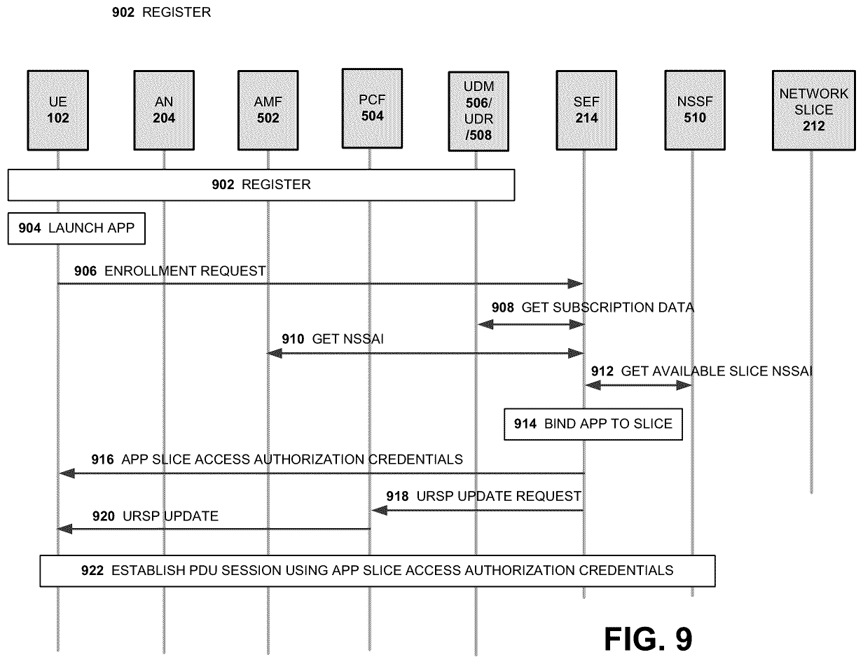

FIG. 8 is a flow diagram of an exemplary process 800 that is associated with system 100 for enrolling application 302 to enable access to network slice services. Process 800 may be performed by one or more components of system 100, such as UE 102 (e.g., application 302, client 304, cryptography DB 312, operating system 306, modem 308, and/or URSP DB 310), access network 204, and/or core network 206 (e.g., network functions 502-512). FIG. 9 illustrates example messages that are exchanged by system 100 during process 800.

As shown in FIG. 8, process 800 may include UE powering up; launching application 302; and UE 102 registering at network 104 (block 802; arrow 902 and block 904). After application 302 launches and UE 102 registers at network 104 (e.g., at AMF 502), application 302 may attempt to start a session via client 304 (block 804). For example, application 302 may invoke an API to start a session via client 304. When client 304 receives the request, client 304 may determine whether application 302 is enrolled at network 104 (block 806), by looking up cryptography DB 312 (e.g., whether there are slice authorization credentials assigned to the application ID). If client 304 determines that application 302 is already enrolled at network 104 (block 806: YES), client 304 may send a request for session to modem 308 (block 808). Process 800 may then proceed to block 818.

At block 806, if client 304 determines that application 302 is not enrolled at network 104 (block 806: NO), client 304 may send a request to enroll application 302 to SEF 214 (block 810; arrow 906) via operating system 306 and modem 308. The request may include a UE ID, an application ID for application 302, a TD (optionally), and/or service requirements for application 302 (e.g., a 5QI or QCI of a service that application 302 needs from network 104, a bandwidth requirement, and/or a latency requirement). As described previously, when enrollment server 602 in SEF 214 receives the enlistment request, enrollment server 602 may obtain a corresponding record 700 in app-slice bindings DB 604 and insert at least some of the information provided in the request in the record 700.

Process 800 may further include SEF 214 collecting information needed to select and assign a network slice to application 302 (block 812). Collecting the information may include, for example, requesting and getting subscription data from UDM 506 (e.g., NSSAI of network slices 212 to which UE 102 is subscribed) (arrow 908); getting NSSAI from AMF 502 (e.g., NSSAI of requested network slices 212 provided at the UE registration to AMF 502 or getting NSSAI of network slices 212 to which UE 102 is permitted to connect by access network 204) (arrow 910); and/or requesting NSSF 510 to get S-NSSAI or NSSAI of available network slices 212 from which application 302 on UE 102 may receive services (arrow 912). After collecting the information, SEF 214 may select the network slice 212 that meets the service requirements of application 302 and may provide services to application 302 (block 814). After selecting the network slice 212, SEF 214 may then bind application 302 to the selected network slice 212 (block 814; block 914). Binding application 302 to the network slice 212 may include obtaining app slice authorization credentials (e.g., a token) for application 302 (e.g., generating a key or token or obtaining a certificate from a secure device); and storing the application ID of application 302, the slice ID of the selected network slice 212, and the slice authorization credentials in app-slice bindings DB 604. SEF 214 may forward the credentials as part of an enrollment reply to client 304 on UE 102 (block 814; arrow 916) using secure communication protocols (e.g. using end-to-end secure objects such as JavaScript Object Notation (JSON) Web Objects with encryption and integrity) that provide confidentiality and integrity to the credentials so that the slice authorization credentials are not tampered with or cannot be deciphered by un-authorized entities.

Process 800 may further include SEF 214 obtaining a URSP rule and sending the obtained URSP rule to UE 102 (block 816). For example, SEF 214 may generate a URSP rule that maps the traffic descriptor of application 302 to the selected network slice 212. SEF 214 may then request PCF 504 to send the URSP rule to UE 102 (arrow 918). In response, PCF 504 may forward the URSP rule to UE 102 (arrow 920) via access network 204. In another implementation, SEF 214 may obtain the URSP from a network administrator or from PCF 504.

Although not shown, actions shown in blocks 814 and 816 may be performed in different order or in parallel. Similarly, messages that are exchanged at arrows 916, 918, and 920 may be performed in different order. For example, the URSP rule may be sent prior to sending the app slice authorization credentials or at the same time.

After the enrollment, application 302 on UE 102 may send a request for session to modem 308. In response, modem 308 may send a request to connect to the selected network slice for application 302 (block 818). UE 102 and system 100 may then establish a PDU session between UE 102 and the selected network slice 212 (block 818; block 922). To establish the session, UE 102 may authenticate application 302 using the slice authorization credentials provided by SEF 214.

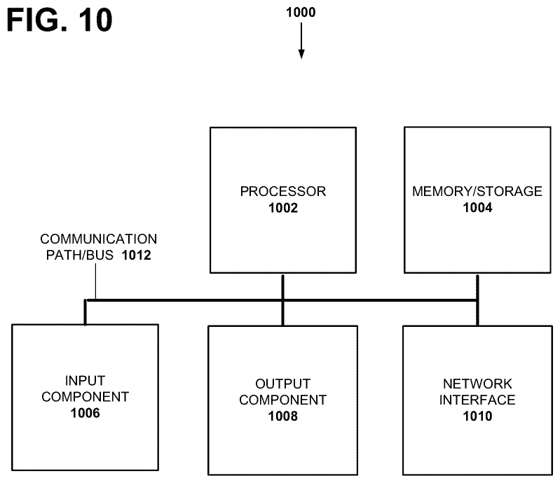

FIG. 10 depicts exemplary components of an exemplary network device 1000. Network device 1000 may correspond to or be included in any of the devices and/or components illustrated in FIGS. 1-3, 5, 6, and 9 (e.g., UE 102, access network 204, core network 206, data network 208, access station 210, SEF 214, AMF 502, PCF 504, UDM 506m YDR 508, NSSF 510, etc.). In some implementations, network devices 1000 may be part of a hardware network layer on top of which other network layers and network functions (NFs) may be implemented.

As shown, network device 1000 may include a processor 1002, memory/storage 1004, input component 1006, output component 1008, network interface 1010, and communication path 1012. In different implementations, network device 1000 may include additional, fewer, different, or different arrangement of components than the ones illustrated in FIG. 10. For example, network device 1000 may include line cards, switch fabrics, modems, etc.

Processor 1002 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1000 and/or executing programs/instructions.

Memory/storage 1004 may include static memory, such as read only memory (ROM), and/or dynamic memory, such as random access memory (RAM), or onboard cache, for storing data and machine-readable instructions (e.g., programs, scripts, etc.). Memory/storage 1004 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1004 may be external to and/or removable from network device 1000. Memory/storage 1004 may include, for example, a Universal Serial Bus (USB) memory stick, a dongle, a hard disk, off-line storage, a Blu-Ray® disk (BD), etc. Memory/storage 1004 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1006 and output component 1008 may provide input and output from/to a user to/from network device 1000. Input/output components 1006 and 1008 may include a display screen, a keyboard, a mouse, a speaker, a microphone, a camera, a DVD reader, USB lines, and/or other types of components for obtaining, from physical events or phenomena, to and/or from signals that pertain to network device 1000.

Network interface 1010 may include a transceiver (e.g., a transmitter and a receiver) for network device 1000 to communicate with other devices and/or systems. For example, via network interface 1010, network device 1000 may communicate over a network, such as the Internet, an intranet, cellular, a terrestrial wireless network, a satellite-based network, optical network, etc. Network interface 1010 may include a modem, an Ethernet interface to a LAN, and/or an interface/connection for connecting network device 1000 to other devices.

Communication path or bus 1012 may provide an interface through which components of network device 1000 can communicate with one another.

Network device 1000 may perform the operations described herein in response to processor 1002 executing software instructions stored in a non-transient computer-readable medium, such as memory/storage 1004. The software instructions may be read into memory/storage 1004 from another computer-readable medium or from another device via network interface 1010. The software instructions stored in memory/storage 1004, when executed by processor 1002, may cause processor 1002 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 8 and 9, the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor to:
receive, from a User Equipment device (UE) over a wireless connection, a request to enroll an application installed on the UE to receive a service from a network slice;
select a network slice to provide the service to the application on the UE;
bind the application on the UE to the selected network slice; and
send an enrollment reply to the UE.

2. The device of claim 1, wherein when binding the application on the UE to the selected network slice, the processor is configured to:
store an identifier that identifies the application, a Single-Network Slice Selection Assistance Information (S-NSSAI) that identifies the selected network slice, and a UE ID for the UE in a database.

3. The device of claim 1, wherein the processor is further configured to:
obtain a UE Route Selection Policy (URSP) rule which, when applied at the UE, causes the UE to identify the selected network slice, and
send the URSP rule to the UE.

4. The device of claim 1, wherein the processor is further configured to:
either obtain from another device a security information comprising one or more of a security token, a security key, or a security certificate or generate the security information; and
include the security information in the enrollment reply prior to sending the enrollment reply to the UE.

5. The device of claim 1, wherein when selecting the network slice, the processor is configured to:
extract, from the request to enroll the application, requirements for providing the service to the application; and
select the network slice based on the requirements.

6. The device of claim 5, wherein the requirements include at least one of:
a latency requirement;
a bandwidth requirement; or
a Quality-of-Service (QOS) requirement.

7. The device of claim 1, wherein the processor is further configured to:
receive, from the UE, a request to de-enroll the application; and
unbind the application from the network slice.

8. The device of claim 1, wherein the UE is configured to:
establish a Protocol Data Unit (PDU) session between the UE and the selected network slice.

9. The device of claim 8, wherein when the UE establishes the PDU session, the UE is configured to:
use a token to authenticate the application at a network, which includes the network slice, for the application to access the network slice.

10. A method comprising:
receiving, from a User Equipment device (UE) over a wireless connection, a request to enroll an application installed on the UE, to receive a service from a network slice;
selecting a network slice to provide the service to the application on the UE;
binding the application on the UE to the selected network slice; and
sending an enrollment reply to the UE.

11. The method of claim 10, wherein binding the application on the UE to the selected network slice includes:
storing an identifier that identifies the application, a Single-Network Slice Selection Assistance Information (S-NSSAI) that identifies the selected network slice, and a UE ID for the UE in a database.

12. The method of claim 10, further comprising:
obtaining a UE Route Selection Policy (URSP) rule which, when applied at the UE, causes the UE to identify the selected network slice, and
sending the URSP rule to the UE.

13. The method of claim 10, further comprising:
either obtaining from another device a security information comprising one or more of a security token, a security key, or a security certificate or generate the security information; and
including the security information in the enrollment reply prior to sending the enrollment reply to the UE.

14. The method of claim 10, wherein selecting the network slice includes:
extracting, from the request to enroll the application, requirements for providing the service to the application; and
selecting the network slice based on the requirements.

15. The method of claim 14, wherein the requirements include at least one of:
a latency requirement;
a bandwidth requirement; or
a Quality-of-Service (QoS) requirement.

16. The method of claim 10, further comprising:
receiving, from the UE, a request to de-enroll the application; and
unbinding the application from the network slice.

17. The method of claim 10, further comprising:
establishing, by the UE, a Protocol Data Unit (PDU) session between the UE and the network slice.

18. The method of claim 17, wherein establishing the PDU session includes:
using a token to authenticate the application at a network, which includes the network slice, to permit the application to access the network slice.

19. A non-transitory computer-readable medium comprising processor-executable instructions, which when executed by a processor included in a device, cause the processor to:
receive, from a User Equipment device (UE) over a wireless connection, a request to enroll an application installed on the UE to receive a service from a network slice;
select a network slice to provide the service to the application on the UE;
bind the application on the UE to the selected network slice; and
send an enrollment reply to the UE.

20. The non-transitory computer-readable medium of claim 19, wherein when binding the application on the UE to the selected network slice, the processor is configured to:
store an identifier that identifies the application, a Single-Network Slice Selection Assistance Information (S-NSSAI) that identifies the selected network slice, and a UE ID for the UE in a database.
